(19) United States
(12) Patent Application Publication
(10) Pub. No.: US 2008/0097864 A1
(43) Pub. Date: Apr. 24, 2008

(54) Systems and methods for an intelligent toolbar that provides contextual bidding opportunities

(75) Inventors: Parag Patel, Los Angeles, CA (US); Malik Magdon-Ismail, Loudonville, NY (US)

Correspondence Address: Parag Patel, 4708 La Villa Marina, Unit G, Marina del Rey, CA, 90292, US

(73) Assignee: SWOOGE, LLC, Loudonville, NY (US)

(21) Appl. No.: 11/552,268

(22) Filed: Oct. 24, 2006

(51) Int. Cl. G06Q 30/00

(52) U.S. Cl. 705/26

(57) ABSTRACT

Online bidding opportunities on goods and/or services are targeted to an individual user based, in part, on the user's navigation history. User navigation (e.g., Web browsing, search requests, etc.) may be tracked, recorded and maintained. User navigation information may be used to determine content-relevant and personalized bidding opportunities for goods and/or services from one or more merchants or auctioneers. By doing so, the bidding opportunities presented are more relevant to the user, reduce the research time and effort expended by such user in exploring multiple websites to purchase such goods and/or services and provide merchants and auctioneers with “hot” leads.

### FIELD

The present invention relates to graphical user interfaces and online bidding systems. In particular, the present invention relates to systems and methods for providing an intelligent toolbar that provides contextual and non-contextual bidding opportunities to the user.

### BACKGROUND

Recently, online surfing and e-commerce have become popular. For example, as the number of people using the Internet has exploded, online merchants and advertisers have come to appreciate media and services offered over the Internet as a potentially powerful way to advertise and sell their products and services.

Interactive bidding opportunities provides opportunities for merchants to target their products or services to a receptive audience. That is, targeted products or services are more likely to be useful to end users since the products or services may be relevant to a need inferred from some user activity (e.g., relevant to a user's search query to a search engine, relevant to content in a document requested by the user, etc.)

Other contextual placement technology use navigation history information of users browsing the Internet. However, these current methods have problems. For example, advertising delivery by DoubleClick can use only history information that can be gleaned from activity on pages that have DoubleClick advertisements. Unfortunately, since that history information is often sparse and incomplete, the advertisements delivered could be better targeted.

Spyware approaches such as those used by Gator can collect full navigation history, but present advertisements in an intrusive, often annoying way to the user. Specifically, since these products generate popup advertisements over Websites without the permission of such Websites, these products are generally seen by users as unfriendly, undesirable programs. Nor do they provide direct bidding opportunities, which reduce the research time and effort expended by users in exploring multiple websites to purchase such goods and/or services and provide merchants and auctioneers with “hot” leads.

### SUMMARY OF THE INVENTION

Methods and apparatus are provided for monitoring an Internet user's navigational history and enabling such user to enter bids on relevant goods or services using a toolbar or other similar browser software. Using navigational history and other monitored data, the toolbar and embedded software determines whether the user is looking for a specific good/service (e.g. an ipod) or for a category of goods/services (e.g. mp3 players). If the former, then it notifies the user if the user would like to place a bid (e.g. within a specific area of the toolbar, on a separate webpage, via e-mail or other delivery method) for the specific good/service; if the latter, then the toolbar presents the user with various specific items within the category (e.g., iPod, Dell Digital Jukebox, Rio Carbon, etc.) and enables the user to place bids on one, all or some of those items. The toolbar may also enable placing bids on auction sites (e.g. eBay). This “on the fly” optimization method is specific to a given user. Merchant and/or auction web sites are provided with the bidding information and may accept or decline the bid. In some embodiments, acceptance of a bid may consummate a transaction.

The present invention overcomes the shortcomings in the prior art (which typically provide only relevant advertisements) by enabling a user, who has agreed to have his or her navigation history tracked, to bid directly for specific relevant goods and/or services across multiple merchant and auction websites simultaneously. This allows the user to purchase a good or service at a price acceptable to the user and reduces the time and effort that a user typically spends in separately accessing merchant web sites, comparison shopping sites or auction sites. This also benefits the merchants or auctioneers by presenting them with “hot” leads for sales of specific goods or services.

### BRIEF DESCRIPTION OF THE DRAWINGS

FIG. 1 is a block diagram overview of a system according to some embodiments.

FIG. 2 is a flow chart of a method according to some embodiments.

FIG. 3 illustrates a user display according to the embodiment of FIG. 2.

FIG. 4 is a block diagram of a user device according to some embodiments.

FIG. 5 is a block diagram overview of a system according to some embodiments.

### DETAILED DESCRIPTION

The present invention may involve novel methods, apparatus, message formats, and/or data structures for helping to serve useful content-relevant bidding opportunities using the navigation history information and/or other user-submitted information (e.g. search requests, demographic information, etc.). The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. Note that any of the methods described herein may be performed by hardware, software (including microcode), firmware, or any combination thereof. For example, a storage medium may store thereon instructions that when executed by a machine result in performance according to any of the embodiments described herein. Thus, the present invention is not intended to be limited to the embodiments shown and the inventor regards his invention as any patentable subject matter described.

A user who accesses information via a web browser may be interested in receiving information about how to submit bids to purchase goods and/or services that the user is researching or has researched. For example, a user accessing or searching for one or more web sites associated with a particular product or service might like to be able to offer a bid for such product or service simultaneously across one or more merchants or auctioneers. Such user may also desire to know which, if any, recent bids (including details of such bids) culminated in a completed transaction.

As used herein, the term “toolbar” generally refers to a graphical user interface (GUI) having one or more buttons, icons, menus, and/or other user selectable features operable to send a command, trigger an event, initiate a software program, open an executable file, and/or otherwise execute a macro or other program code. Toolbars may reside within the GUI of a program or other software application, or may function and/or exist independent from any application or operating system. For example, web browser programs such as MICROSOFT.RTM. INTERNET EXPLORER.RTM. generally include a toolbar displayed horizontally across the upper portion of the web browser's GUI. Another example of a “plug-in” toolbar is the GOOGLE™ toolbar. Toolbars may “float” independently of any opened applications or may be “docked” in various locations in an operating system GUI (such as in the system tray of various MICROSOFT®WINDOWS™ operating systems).

In the primary embodiment, a toolbar presents bidding opportunities to the user based on the user's navigational history (e.g. URLs, search queries, time and date of search or request, geographical region and the like). The toolbar may additionally include a “bidbar” to enable a user to access bidding opportunities actively by entering goods or services in a text box (a user, for example, may choose not to have his or her navigation history monitored, but may still desire to have the option to receive bidding opportunities; other uses may choose to have their navigation history monitored, but may want to retrieve bidding opportunities without waiting for the software to provide such opportunities). The toolbar may additionally also include a “searchbar” which can help users access information via a web browser (e.g. the GOOGLE™ toolbar provides results from a single search engine); as indicated above, search queries may also be monitored as part of a user's navigation history. In some embodiments a toolbar may include other features including, but not limited to, text boxes, forms, graphics, video, audio, and/or various menus such as drop down, pick-list, expandable, and/or dynamic menus.

System Overview

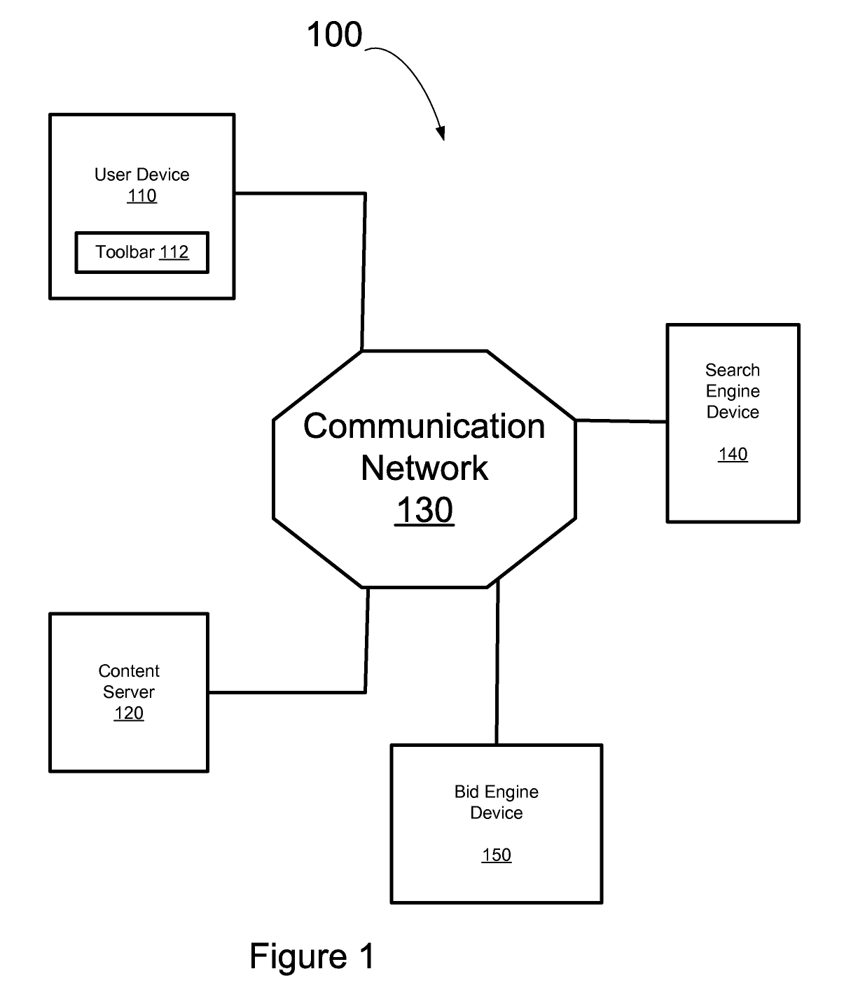

Turning now in detail to the drawings, in FIG. 1 a block diagram of a system 100 is depicted for use in explanation, but not limitation, of described embodiments. Upon reading this disclosure, those skilled in the art will appreciate that different types, layouts, quantities, and configurations of systems may be used.

In some embodiments, a user device 110 may include a toolbar 112 and may access information from a content server 120 via communication network 130. The toolbar 112 may also, according to some embodiments, be used to facilitate the viewing and/or dissemination of the present web page's and/or web site's ranking (e.g. Google ranking). The user device 110 may communicate via network 130 with a search engine device 140. For example, in some embodiments a user may utilize the toolbar 112 to enter a search term or other information associated with a search and/or query. The user device 110 may then transmit information associated with the query to the search engine device 140. The search engine device 140 may, at least in part in response to the user's query for example, transmit information associated with a search result to the user device 110 (e.g., a web page including links that are ranked and associated with appropriate content servers 120). Alternatively, or in addition, a user may use the toolbar 112 to transmit a query to the bid engine device 150 for a bidding opportunity. The bid engine 150 may, at least in part in response to the query, transmit search results about bidding opportunities on relevant goods and/or services. The results may be partially or wholly displayed within, on, or adjacent to the toolbar 112. Alternatively, depending on the user's preference, the results may be displayed on a pop-up or other new web page(s) or via e-mail provided by the content server 120 using the information provided by the search engine device 140 and/or the bid engine device 150.

As used herein, devices (such as the user device 110, the content server 120, the search engine device 140 and the bid engine device 150) may communicate via the communication network 130, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Note that the devices shown in FIG. 1 need not be in constant communication. For example, the user device 110 may only communicate with the content server 120 via the Internet on an as-needed basis. In some embodiments, for example, the user device 110 may be a Personal Computer (PC) that intermittently utilizes a dial-up connection to the Internet via an Internet Service Provider (ISP). In other embodiments the user device 110 may be in constant and/or high-speed communication with the content server 120 and/or with the search engine device 140 through the use of any known or available connection device such as a cable or Digital Subscriber Line (DSL) modem. According to some embodiments, the communication network 130 may be or include multiple networks of varying type, configuration, size, and/or functionality.

Although a single user device 110 and a single content server 120 are illustrated in FIG. 1, any number of these devices may be included in the system 100. Similarly, any number of the other devices described herein may be included in the system 100 according to some embodiments. A single content server 120 may, for example, be in communication with multiple user devices 110. In some embodiments, multiple content servers 120 may provide various information such as bidding opportunities and/or web pages to one or more user device 110.

The user device 110 and the content server 120 may be any known or available devices capable of performing the various functions described herein. The user device 110 may be, for example: a PC, a portable computing device such as a Personal Digital Assistant (PDA), an interactive television device, or any other appropriate storage and/or communication device. Either or both of the content server 120 and the search engine device 140 may be, for example, content servers such as web servers.

Opt-In Bidding Service

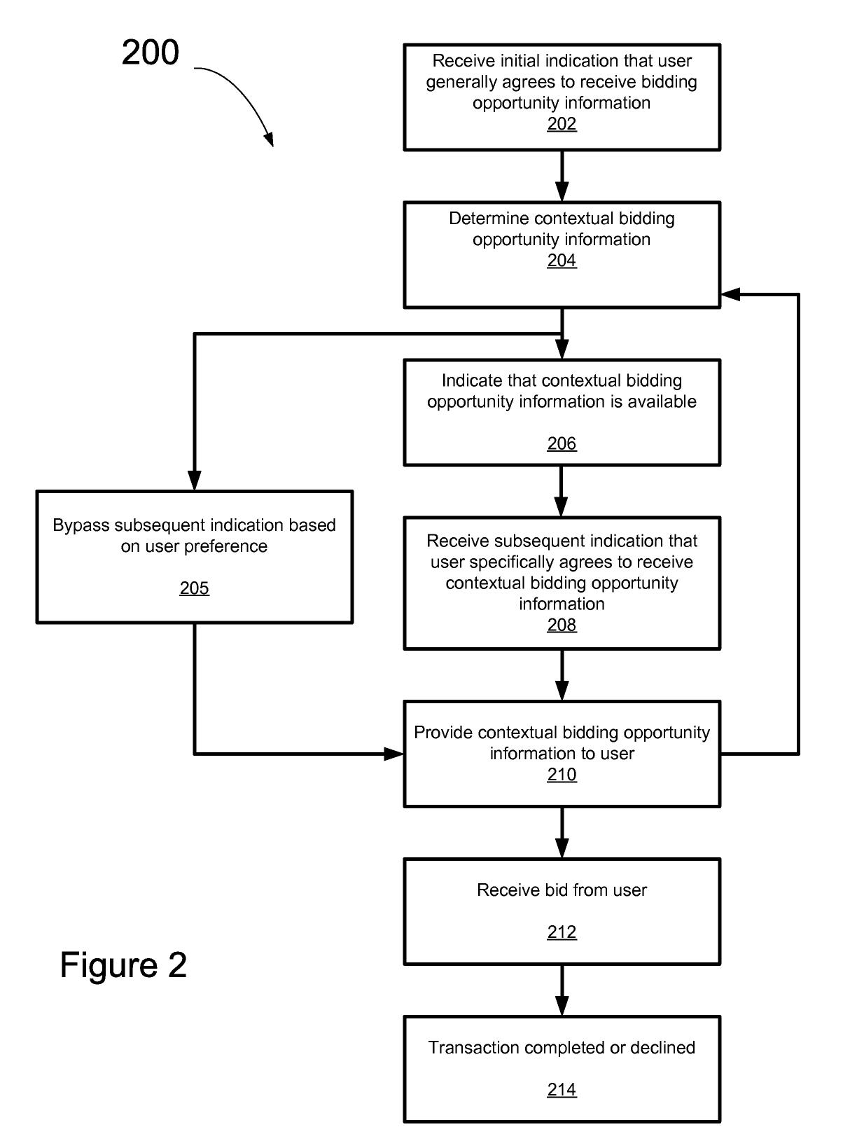

Turning now to FIG. 2, a flow chart of a method 200 according to some embodiments is shown. The method 200 shown in FIG. 2 may be performed, for example, by the user device 110 described in conjunction with FIG. 1 herein.

In some embodiments, an initial indication may be received from a user, at 202. In particular, the user may indicate that he or she generally agrees to permit the tracking of the user's website navigation, search and other history and to receive bidding opportunities and/or other information based, in part, on such website navigation information. The user may also agree to provide user's personal information (e.g. gender, age, likes, dislikes, geographical locations, etc.) and preferences (e.g. how to receive bidding opportunity information—for example, by e-mail, on the screen, on the toolbar only, and the like) to enhance the quality and relevance of presented bidding opportunities. In this regard, the user might click on an “I Agree” button when installing a software program or may indicate agreement to accept such materials by, for example, signing up for a particular service, newsletter, or software download. Other indications may include, but are not limited to, verbal or other express indications and various implied indications. Once downloaded, a user may configure a toolbar (such as toolbar 112) by inputting preferences (for example, as described below, a user may desire an indication that a bidding opportunity is available before presentation or may prefer to have bidding opportunities and/or other information be displayed automatically; a user may also choose to disable the navigation monitoring feature (if the user is concerned about privacy), and elect only to input text into the bidbar to access relevant bidding opportunities).

The method 200 may continue at 204, where contextual bidding opportunities information may be locally determined. For example, an application executing on the user device might monitor which web sites are being accessed by a web browser. The determination might be based on keywords (on current and recently viewed webpages), user preferences and data, URL information, and/or meta-tags within Hypertext Markup Language (HTML) information. Some examples of contextual bidding opportunities are those that are served due to matches of a search term and/or query, content on a web page (or recently viewed web pages), and a URL string. Consider a user who accesses an online travel web site. In this case, the contextual bidding opportunity might be the opportunity to bid on a travel product (e.g. luggage) or service (e.g. a bid for an airline flight) that may be fulfilled by partner vendors. In some embodiments, the URL of the travel site may be known to be associated with travel services, for example. Users visiting such sites may generally therefore be considered to be interested in travel-related bidding opportunities.

In some embodiments, at 206, information may be provided to the user to indicate that the contextual bidding opportunities are available. For example, a button might be added to a toolbar to indicate that contextual bidding opportunities are available. In some embodiments the button, icon, graphical, audio and/or visual indication associated with available bidding opportunities may be bold, italicized, and/or may flash, move, and/or otherwise be formatted to draw the attention of the user and/or a box in which the user may enter a bid amount may appear. For example, a user may visit an mp3 website store using a browser and/or a toolbar. If a relevant bidding opportunity is available (e.g. for an Apple ipod), a button on the user's toolbar may flash, become active, be given focus, and/or otherwise indicate to the consumer that contextual information is available.

Depending on the user's preference, at 205, he or she may bypass 206. In this situation and based on mp3 example given above, a graphic of an iPod may appear on, scroll down from the toolbar or otherwise appear on the screen with a bid box instead of a button displaying that a bidding opportunity is available. In such case, a user may directly proceed to entering and submitting an offer using the bid box (210).

If the user decides not to select the by-passing step, 205, then steps 206 and 208 will apply. At 208, a subsequent indication may be received from the user. In particular, the user may indicate that he or she specifically agrees to receive the contextual bidding opportunities. For example, the user might click on the button that was added to the toolbar (or an existing button associated with contextual information that became active, for example). In some embodiments, the user may provide any other indication that is known, available, and/or described herein. According to some embodiments, a user may provide an implied indication. For example, a pre-set time period (such as ten seconds) may elapse, after which the contextual information is automatically displayed. In some embodiments, the user may provide an indication by enabling and/or configuring such a time-lapse feature within the software of a toolbar, for example.

The method 200 may continue by providing the contextual bidding opportunity to the user (e.g., a bid box for the total price of an airline ticket may be displayed to the user), at 210. In some embodiments, the contextual information may be displayed to the user in the form of a list, table, and/or hyperlink. For example, when multiple products (e.g., iPod, Dell Digital Jukebox, Rio Carbon, etc.) within a category (e.g. mp3 players) are available, a list of the individual products (with bid-boxes next to each product) may be provided to the user.

In some embodiments, the user may also be presented with links for more information or similar products. For example, if the user desires a different model (e.g. a black-colored ipod), he or she can select “similar products”, and choose the appropriate product from a list before entering his or her bid. The user may alternatively select one or more items from the list for viewing, printing, and/or for receiving further related information.

At 212, the user may then enter one or more bids for one or more of the specified products. In some embodiments, acceptance of one bid may automatically cancel remaining bids. Generally, bids may be accepted or declined by merchants on a live-time or time-delayed basis, at 214. Depending on a user or merchant/auctioneer's preference, a transaction may be made binding upon acceptance of a bid by a merchant/auctioneer or a confirmation by the user (communicated via e-mail, toolbar or otherwise) to accept the merchant/auctioneer's initial acceptance or counter-bid.

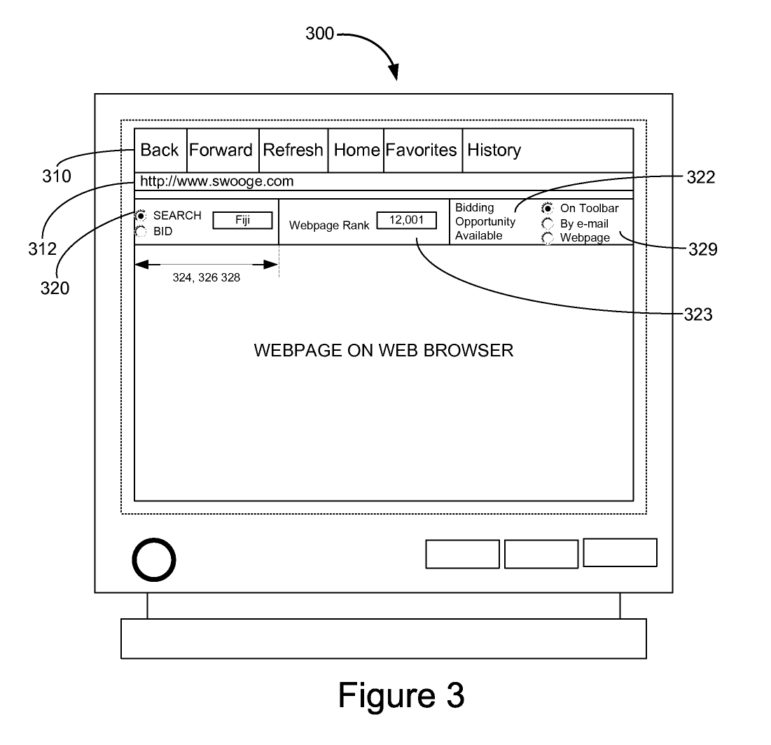

Referring now to FIG. 3, an example of a user display 300 according to some embodiments is shown. The user display 300 may, for example, be associated with the method 200 described above. In some embodiments, the display 300 may include a typical browser toolbar 310, an address bar 312, and a toolbar 320. The toolbar 320 may, according to some embodiments, be similar to the toolbar described above 112. In some embodiments, the toolbar 320 may include a “Bidding Opportunity Available” button 322 and/or a searchbar 324 and/or a bidbar 328 (alternatively a single text box may be used interchangeably, at the user's option, to accommodate both the searchbar and a bidbar 326). The “Bidding Opportunity Available” button 322 may, according to some embodiments, appear and/or otherwise become active when contextual bidding opportunities are available. The user may then select a preferred method of delivery of the bidding opportunity; the bidding opportunity (or other contextual information) may be (e.g., a small bidding opportunity might appear in place of the button, might scroll down from the button, may appear elsewhere on the user's screen, redirect user to another webpage or open a new webpage, and/or may be e-mailed to the user). A user may select the preferred delivery mode as an opportunity is presented using selection button (329) or may be permitted to select such method via pre-selected user preferences. In this way, the user may easily realize, for example, that the bidding opportunity is not associated with the web page and decides whether to view the opportunity or to continue surfing.

In some embodiments, the contextual information may be provided based in part on one or more actions, parameters, and/or other metrics associated with the user (and/or with the user device). For example, the user may visit a web site having a URL of “http://www.swooge.com” (such as shown in the address window 312 of FIG. 3). The URL may have a known association with one or more types or categories of products and/or services. The URL may be associated with a company that sells mp3 players, for example. In some embodiments, the association with “mp3 players” may be used to select a contextual bidding opportunity for several specified mp3 players.

According to some embodiments, the contextual information may be similarly selected and/or identified based upon a search term such as the search term “Fiji” 326. In some embodiments, a combination of factors may be used to select and/or identify contextual information. For example, the combination of the URL associated with “travel” and the use of the search term “Fiji” may indicate that the user has an interest in traveling to Fiji. Contextual bidding opportunities such as travel packages for travel to Fiji may therefore be selected, displayed, and/or made available to the user.

In some embodiments, the toolbar may include a section (323) displaying the webpage rank (e.g. Alexa™, Google™ or Swooge™ rank) of the currently viewed webpage.

According to some embodiments, the bid engine 150 may be or include a database matching database 502. For example, relevant bidding opportunities and other informational material may be provided by the bid engine 150. The information from the bid engine 150 may be displayed and/or otherwise accessible within or using the toolbar 112. For example, the toolbar 112 may be associated with and/or contain various rules regarding the display and/or use of bidding opportunities or other material. The bidding opportunity and related information (e.g. recent successful bids for the desired or related products or services, description of products or services) may, for example, be located on and/or otherwise be associated with the toolbar 112. In some embodiments, a displayed bidding opportunity selected for display may be chosen and/or selected based on the user's navigational and/or contextual history. In other words, a bidding opportunity may be displayed and/or activated by the toolbar 112 at least in part in response to a search and/or query initiated by a user operating the user device 110, to the user's navigational history and/or in response to a particular URL navigated to using the user device 110.

User Device

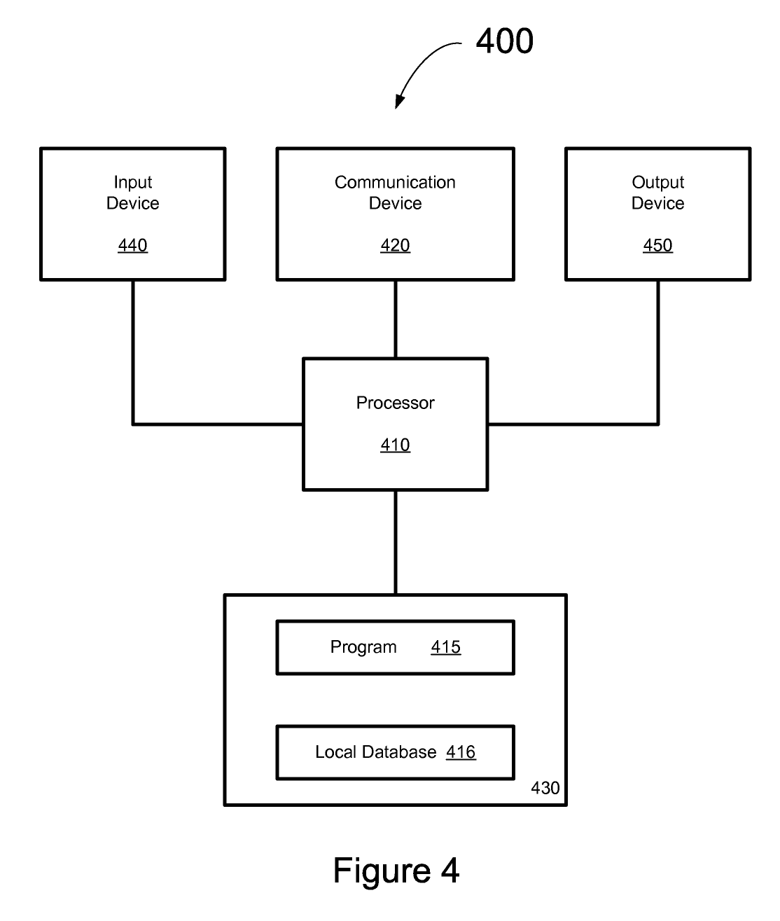

Turning now to FIG. 4, an exemplary user device 400 that may be, for example, descriptive of the user device 110 shown in FIG. 1, and that is in accordance with some embodiments is shown. The user device 400 may include a processor 410, such as one or more INTEL™ processors, coupled to a communication device 420 configured to communicate via a communication network (not shown in FIG. 4). The communication device 420 may be used to communicate, for example, with one or more content servers 120, search engine devices 140 and/or bid engine devices 150 as described in conjunction with system 100 herein. The user device 400 may further include an input device 440 (e.g., a mouse and/or keyboard) and an output device 450 (e.g., a computer monitor).

In some embodiments, the processor 410 may also communicate with a local storage device 430. The local storage device 430 may comprise any appropriate information storage device known or available, including, but not limited to, combinations of magnetic storage devices (e.g., a hard disk drive), optical storage devices, and/or semiconductor memory devices such as Random Access Memory (RAM) devices and Read Only Memory (ROM) devices. The storage device 430 may, for example, store a program 415 for controlling the processor 410. The processor 410 may perform instructions of the program 415, and for example, thereby operate in accordance with embodiments described herein. For example, the processor 410 may arrange for a toolbar (such as toolbar 112, 320) to be displayed to a user.

The program 415 may be stored in a compressed, uncompiled and/or encrypted format. The program 415 may furthermore include other program elements, such as an operating system, a database management system, and/or device drivers used by the processor 410 to interface with peripheral devices.

As used herein, information may be “received” by or “transmitted” to, for example: (i) the user device 400 from another device; or (ii) a software application or module within the user device 400 from another software application, module, or any other source. Although the components 410-450 are described with respect to a user device 400 (such as user device 110), those skilled in the art will appreciate that the other devices described herein may include these and/or similar components or functionalities. The user device 400 (and other devices) may also include fewer or more components than those shown in FIG. 4.

In some embodiments (such as shown in FIG. 4), the local storage device 430 also may have a local database 416 which may, for example, store or cache information, such as bidding opportunities, user navigational history, and the like, for providing contextual bidding opportunities. In some embodiments, the information stored in local database 416 may be used, for example, to provide information in accordance with system 500 described herein.

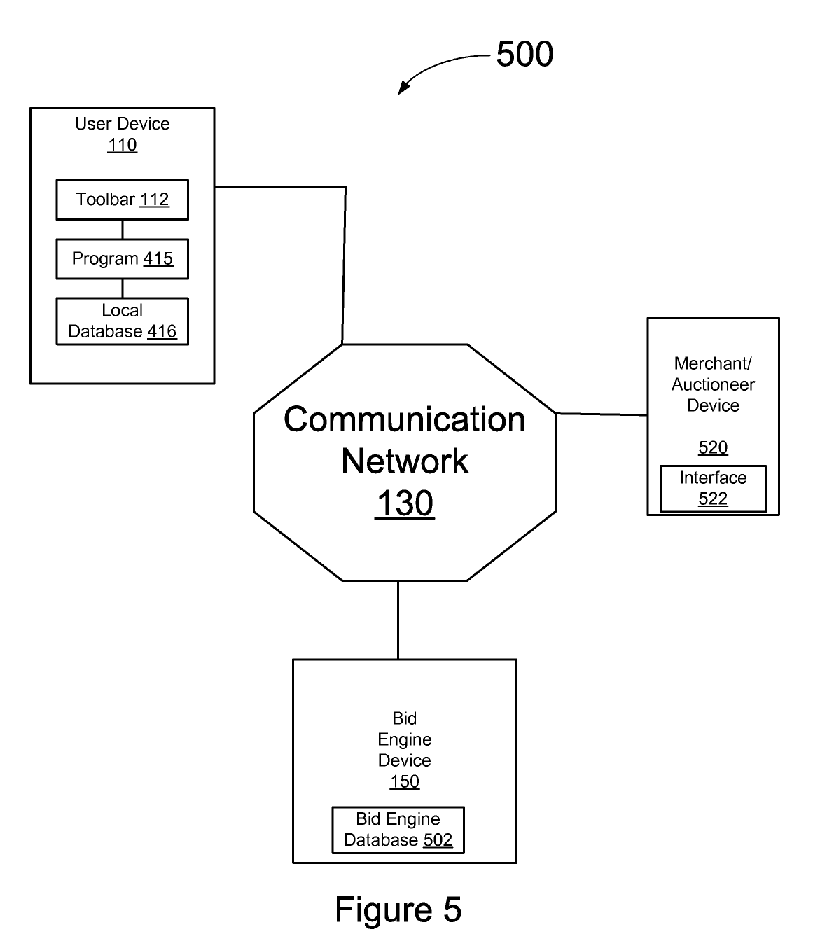

Referring to FIG. 5, a system is shown that enables an intelligent matching of user information with bidding opportunities. On the user device, 110, the program 415 collects the user's personal preferences, navigation information and personal information and stores such information in the local database 416. In some embodiments, the program 415 may additionally store a local bid engine database (within the local database 416) which may be synchronized with the Bid Engine Database 502.

The bid engine device 150 is connected to a merchant/auctioneer device 520 through the communication network. Using an interface 522 (e.g. merchant-specific account webpage) on the merchant/auctioneer device 520, merchants/auctioneers may send their product information (e.g. unique product id codes, product information, lowest acceptable price, time periods for accepting bids at various price levels (if applicable), available quantity at various price levels (if applicable), etc.) through the communication network 130 to the bid engine device (150) which stores the information in a bid engine database 502. Merchants/auctioneers may also use the interface 522 to accept or decline bids from users on a real time basis.

The information stored in the local database 416 (which may include the local bid database engine in some embodiments) is also communicated to the bid engine database 502 (via the communication network 130) and bid engine device 150; updated information (including matched bid opportunities) is sent back to the user device through the connection network 130 at various intervals. In some embodiments, the frequency of communications may vary based on several factors as determined by the software 415 (as described below). Such factors may include user preferences (e.g. use of computer resources, desire to receive extremely relevant bidding opportunities (i.e. fewer opportunities, but more relevant to a user's needs as more user information is collected before an opportunity is displayed) versus relevant opportunities (more bidding opportunities shown, but based on less user information, resulting in less optimal matches), short-term differences in user information versus long term trends (e.g. a professor who typically looks for reference materials is surfing to purchase a iPod for the first time, suggesting that the professor is going to make a purchase sooner rather than later), high selling items (user is looking for popular items, e.g. ipods), trendy or seasonal items (e.g. jackets at the beginning of winter versus at the end of winter—which then would constitute bargain shopping), staleness of local database information (e.g. information such as tickets for past events), amount of internet use or bidding activity (frequent users or bidders may get more frequent updates). The software product 415 may combine the above factors with the user's information (personal and navigational) to retrieve matched bidding opportunities from the bid engine 150 and bid engine database 502 and display the opportunities to the user via the toolbar 112 as described above.

Hence, in a preferred embodiment, the software product is customized to a particular user and may provide better matched opportunities as it collects more information about the user. The software may implements methods of artificial intelligence to perform the above customized analysis as described below:

The software program, 415, collects inputs which include:

User preferences;

Long term and short term historical browsing profile of the user;
Based on pages browsed and overall categorical information of webpages, including categorical information in the bidding engine data base, the long term and short term browsing profile of the user are categorized into one or more categories.

Categories have associated attributes, such as, but not limited to:
Current-fashionability-value (CFV): for example, summer clothing toward the end of spring has a high CFV; CFV can be automatically determined by Artificial Intelligence (AI) systems based on an average over many users' recent purchases versus historical purchases.
Specificity (SPF): for example, is the user browsing a general category such as electronics (lower SPF) versus is the user browsing for an IPOD musical device (higher SPF).
Deviations of Short Term from Long Term (StLtDev): how different is the user's short term historical browsing compared to long term historical browsing. Such a parameter could for example be used to indicate a recent urge of the user versus a long term interest.

Based on the parameters collected (including but not limited to those as described above) and based on the Local Database, 416, the software automatically determines how often to synchronize with the Bid Engine Database 502 and how often to present the user with bid opportunities as well as what bid opportunities to present to the user.

### Additional Embodiments

The following illustrates various additional embodiments. These additional embodiments do not constitute a definition of all possible embodiments, and those skilled in the art will understand that many other embodiments may be possible and/or practicable. Further, although the following embodiments are briefly described for clarity, those skilled in the art will understand how to make any changes, if necessary, to the above-described apparatus and methods to accommodate these and other embodiments and applications.

According to some embodiments, demographic information may be used in combination with search results and/or navigational history to provide more relevant bidding opportunities.

According to some embodiments, “popular searches” can be selected by the user (e.g., the twenty most popular queries). For example, the system might track specific keywords and keyword phrases users are searching for. Merchants and auctioneers could then buy or use these “most searched for” keywords. The ability to track the popularity of each individual keyword and keyword phrase might help determine where user interest and merchant/auctioneer intersect.

The present invention has been described in terms of several embodiments solely for the purpose of illustration. Persons skilled in the art will recognize from this description that the invention is not limited to the embodiments described.

What is claimed is:

1. A method of presenting online bidding opportunity information, comprising: receiving from a user an initial indication that the user generally agrees to receive online bidding opportunity information; locally determining contextual online bidding opportunity information; and providing the contextual online bidding opportunity information to the user at least in part in response to the initial and subsequent indications from the user.

2. The method of claim 1, further comprising: receiving one or more bids by the user.

3. The method of claim 1, further comprising: receiving one or more bids by the user; and canceling all remaining bids after the first acceptance of a bid.

4. The method of claim 1, wherein the contextual online bidding opportunity information is determined local to a user device operated by the user.

5. The method of claim 1, wherein the initial indication includes an acceptance by the user of an end-user license agreement.

6. The method of claim 1, wherein the contextual online bidding opportunity information is determined local to a user device operated by the user.

7. A method of presenting online bidding opportunity information, comprising: receiving from a user an initial indication that the user generally agrees to receive online bidding opportunity information; locally determining contextual online bidding opportunity information; providing information to the user to indicate that the contextual online bidding opportunity information is available; receiving from the user a subsequent indication that the user specifically agrees to receive the online bidding opportunity information; and providing the contextual online bidding opportunity information to the user at least in part in response to the initial and subsequent indications from the user.

8. The method of claim 7, further comprising: receiving one or more bids by the user.

9. The method of claim 7, further comprising: receiving one or more bids by the user; and canceling all remaining bids after the first acceptance of a bid.

10. The method of claim 7, wherein the contextual online bidding opportunity information is determined local to a user device operated by the user.

11. The method of claim 7, wherein the initial indication includes an acceptance by the user of an end-user license agreement.

12. The method of claim 7, wherein the contextual online bidding opportunity information is determined local to a user device operated by the user.

13. An apparatus, comprising: a processor; and a storage device in communication with said processor and storing instructions adapted to be executed by the processor to: receive from a user an initial indication that the user generally agrees to receive online bidding opportunity information; locally determine contextual online bidding opportunity information; provide information to the user to indicate that the contextual online bidding opportunity information is available; receive from the user a subsequent indication that the user specifically agrees to receive the contextual online bidding opportunity information; and provide the contextual online bidding opportunity information to the user at least in part in response to the initial and subsequent indications from the user.
